(19) United States
(12) Patent Application Publication
(10) Pub. No.: US 2015/0048779 A1
(43) Pub. Date: Feb. 19, 2015

(54) BATTERY SYSTEM, METHOD OF CONTROLLING BATTERY SYSTEM AND ENERGY STORAGE SYSTEM INCLUDING THE SAME

(71) Applicant: SAMSUNG SDI CO., LTD., Yongin-si (KR)

(72) Inventor: Jong-Pil LEE, Yongin-si (KR)

(73) Assignee: SAMSUNG SDI CO., LTD., Yongin-si (KR)

(21) Appl. No.: 14/193,107

(22) Filed: Feb. 28, 2014

(30) Foreign Application Priority Data
Aug. 16, 2013 (KR) 10-2013-0097342

(51) Int. Cl. H02J 7/00

(52) U.S. Cl. CPC H02J 7/0003; H02J 7/0013
USPC 320/106

(57) ABSTRACT

A method of controlling a battery system includes transmitting a synchronizing signal from a first battery management system (BMS) to a plurality of second BMSs, receiving response signals from the second BMSs, and transmitting identification (ID) information from the first BMS to respective ones of the second BMSs after the response signals are received. The first BMS receives response signals from the second BMSs when corresponding battery trays are connected. The ID information for the second BMSs are different from one another.

### CROSS-REFERENCE TO RELATED APPLICATION

Korean Patent Application No. 10-2013-0097342, filed on Aug. 16, 2013, and entitled: “Battery System, Method Of Controlling Battery System and Energy Storage System Including The Same,” is incorporated by reference herein in its entirety.

### BACKGROUND

1. Field

One or more embodiments herein relate to operation of a battery.

2. Description of the Related Art

Energy storage systems continue to be of interest to system designers, and especially ones which do not damage the environment. One type of system includes a battery that stores new renewable energy to be used with an existing power grid system.

### SUMMARY

In accordance with one or more embodiments, a method of controlling a battery system includes (a) transmitting a synchronizing signal from a master battery management system (BMS); (b) transmitting a response signal from a slave BMS to the master BMS when a battery tray corresponding to the slave BMS is mounted; (c) transmitting identification (ID) information from master BMS to the slave BMS; (d) setting the received ID information in the slave BMS; and (e) repeating (b), (c), and (d) when one or more additional battery trays having corresponding slave BMSs are mounted.

The method may include sequentially transmitting the ID information of each slave BMS in an order in which corresponding ones of the battery trays are mounted.

The method may include changing a mode of the master BMS to an ID setting mode based on an external input. The external input is generated when an ID setting button is pressed. The method may also include changing the mode of the master BMS to a normal mode based on another external input. The other external input is generated by re-pressing an ID setting button.

The method may include storing the ID information when the mode of the master BMS is changed to the normal mode. The master BMS may communicate with the slave BMS based on controller area network (CAN) communications.

In accordance with another embodiment, a battery system includes at least one slave battery management system (BMS) to control a battery tray including at least one battery cell; and a master BMS to control the at least one slave BMS. The master BMS is configured to transmit a synchronizing signal, receive a response signal from the slave BMS receiving the synchronizing signal, transmit ID information of the slave BMS to the slave BMS, and repeatedly performing receiving of the response signal and transmitting of the ID information whenever an additional battery tray with a corresponding slave BMS is mounted. The slave BMS is configured to receive the synchronizing signal and transmit the response signal to the master BMS, when the battery tray corresponding to the slave BMS is mounted, and to receive the ID information from the master BMS.

The master BMS may sequentially transmit the ID information of each slave BMS in an order in which the battery trays are mounted. The master BMS may enters into an ID setting mode based on an external input. The master BMS may further comprise an ID setting button for entering into the ID setting mode. The master BMS may return to a normal mode based on another external input. The external input may be generated when an ID setting button is re-pressed.

The master BMS may store the ID information when returning to the normal mode. The master BMS and slave BMS perform controller area network (CAN) communications.

In accordance with another embodiment, an energy storage system includes a power generation system; a power grid system; and a battery system including at least one slave battery management system (BMS) for controlling a battery tray including at least one battery cell and a master BMS for controlling the at least one slave BMS, wherein the battery system, the power generation system, the power grid system are connected to supply power to a load. The master BMS transmits a synchronizing signal, receives a response signal from the slave BMS on which the battery tray receiving the synchronizing signal is mounted, transmits ID information of the slave BMS to the slave BMS, repeatedly performs the receiving and transmitting of the ID information when an additional battery tray is mounted. The master BMS sequentially transmits the ID information of each slave BMS in an order in which the battery trays are mounted.

In accordance with another embodiment a method of controlling a battery system includes transmitting a synchronizing signal from a first battery management system (BMS) to a plurality of second BMSs; receiving response signals from the second BMSs; and transmitting identification (ID) information from the first BMS to respective ones of the second BMSs after the response signals are received, wherein the ID information for the second BMSs are different from one another. The response signals from the second BMSs are sequentially received by the first BMS. The first BMS receives response signals from the second BMSs when corresponding battery trays are connected.

### BRIEF DESCRIPTION OF THE DRAWINGS

Features will become apparent to those of skill in the art by describing in detail exemplary embodiments with reference to the attached drawings in which:

FIG. 1 illustrates an embodiment of an energy storage system;

FIG. 2 illustrates an embodiment of a battery system;

FIGS. 3A through 3D illustrate examples of operations of a rack battery management system (BMS) and a tray BMS for setting up an ID; and

FIG. 4 illustrates an embodiment of a method of controlling a battery system.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

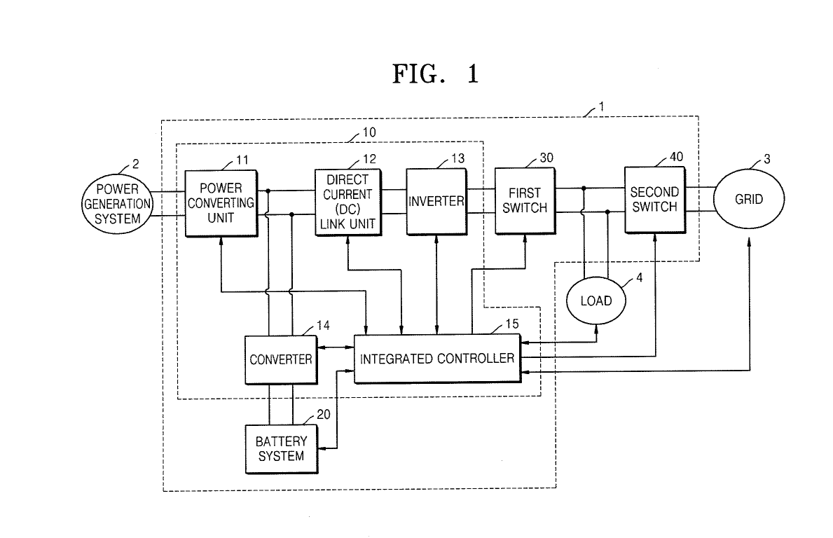

FIG. 1 illustrates an embodiment of an energy storage system 1 that is connected to a power generation system 2 and a grid 3 to supply power to a load 4.

The power generation system 2 is a system for generating power using an energy source. The power generation system 2 supplies the generated power to the energy storage system 1. The power generation system 2 may be, for example, a solar power generation system, a wind power generation system, a tidal power generation system, or a system which generates power from another source. The source may be any type of source including but not limited to new renewable energy such as solar heat or geothermal heat. In solar application, a solar cell generating electric energy using solar light may be easily installed in a house or a factory, and thus may be efficiently used in the energy storage system 1 installed in a house or a factory.

In one embodiment, the power generation system 2 which may include a plurality of power generation modules arranged in parallel and which generates power using the power generation modules. Such a system may correspond to a large capacity energy system.

The grid 3 may include a power generating station, an electric power substation, a power line, and the like. When the grid 3 is in a normal state, the grid 3 supplies power to the energy storage system 1 for powering a load 4 and/or a battery system 20 based on power received from the energy storage system 1. When the grid 3 is in an abnormal state, power supply from the grid 3 to the energy storage system 1 is stopped. Power supply from the energy storage system 1 to the grid 3 may also be stopped under these circumstances.

The load 4 consumes power generated by the power generation system 2, power stored in the battery system 20, or power supplied from the grid 3. For example, the load 4 may be a house, a factory, or the like.

The energy storage system 1 may store power generated by the power generation system 2 in the battery system 20, and may supply the generated power to the grid 3. The energy storage system 1 may supply power stored in the battery system 20 to the grid 3 or store power supplied from the grid 3 in the battery system 20. Also, when the grid 3 is in an abnormal state (for example, when a power failure occurs in the grid), the energy storage system 1 performs an uninterruptible power supply (UPS) operation to supply power to the load 4. When the grid 3 is in a normal state, the energy storage system 1 may supply the power generated by the power generation system 2 and the power stored in the battery system 20 to the load 4.

According to one embodiment, the energy storage system 1 includes a power conversion system (PCS) 10, the battery system 20, a first switch 30, and a second switch 40.

The PCS 10 converts power of the power generation system 2, the grid 3, and the battery system 20 into power appropriate for a destination and supplies the appropriate power to the destination. The PCS 10 includes a power converting unit 11, a direct current (DC) link unit 12, an inverter 13, a converter 14, and an integrated controller 15.

The power converting unit 11 converts power between the power generation system 2 and the DC link unit 12. The power converting unit 11 sends power generated by the power generation system 2 to the DC link unit 12. At this time, the power converting unit 11 converts a voltage output by the power generation system 2 into a DC link voltage.

The power converting unit 11 may be configured as a power conversion circuit such as a converter or a rectifier circuit according to the type of the power generation system 2. When power generated by the power generation system 2 is DC power, the power converting unit 11 may be a converter for converting one level of DC power into another level of DC power. When the power generated by the power generation system 2 is AC power, the power converting unit 11 may be a rectifier circuit for converting the AC power into DC power.

In particular, when the power generation system 2 is a solar power generation system, the power converting unit 11 may include a maximum power point tracking (MPPT) converter. This converter may perform MPPT controlling to maximize power generated by the power generation system 2 according to variations such as solar insolation or temperature. When the power generation system 2 does not generate any power, the power converting unit 11 may stop operating in order to minimize power consumed by a converter or the like.

A magnitude of the DC link voltage may be unstable due to various factors, such as, for example, a sudden drop in voltage output by the power generation system 2 or the grid 3, generation of a peak load in the load 4, or the like. However, the DC link voltage may need to be stable for normal operations of the converter 14 and the inverter 13. The DC link unit 12 is connected between the power converting unit 11 and the inverter 13 to maintain the DC link voltage at a substantially constant level. The DC link unit 12 may be, for example, a large capacity capacitor.

The inverter 13 is a power conversion device connected between the DC link unit 12 and the first switch 30. The inverter 13 may include an inverter for converting the DC link voltage output from the power generation system 2 and/or the battery system 20 in a discharging mode into an AC voltage of the grid 3. The inverter 13 may include, for example, a rectifier circuit for rectifying the AC voltage of grid 3, for converting the AC voltage into the DC link voltage, and for outputting the DC link voltage for storing power of the grid 3 in the battery system 20 in a charging mode. Alternatively, the inverter 13 may be a bidirectional inverter in which directions of input and output may be changed.

In one embodiment, the inverter 13 may include a filter for removing harmonic waves from an AC voltage output to the grid 3. The inverter 13 may also include a phase locked loop (PLL) circuit for synchronizing a phase of the AC voltage output from the inverter 13 and a phase of an AC voltage of the grid 3 in order to prevent reactive power from being generated. The inverter 13 may also perform functions, for example, including restriction of a voltage fluctuation range, improvement of a power-factor, elimination of a DC component, protection from transient phenomena, and the like. When the inverter 13 is not used, the inverter 13 may stop operating in order to minimize power consumption.

The converter 14 is a power conversion device connected between the DC link unit 12 and the battery system 20. The converter 14 may include a converter for DC-DC converting power stored in the battery system 20 into a voltage level required in the inverter 13, i.e., into the DC link voltage. The converter may output the DC link voltage in a discharging mode. Additionally, or alternatively, the converter 14 may include a converter for DC-DC converting a voltage of power output from the power converting unit 11 or power output from the inverter 13 into a voltage level required in the battery system 20, i.e., into a charging voltage, in a charging mode. According to another alternative, the converter 14 may be a bidirectional converter in which directions of input and output may be changed. When the battery system 20 does not need to be charged or discharged, the converter 14 may stop operating to minimize power consumption.

The integrated controller 15 monitors states of the power generation system 2, the grid 3, the battery system 20, and the load 4 and controls operations of the power converting unit 11, the inverter 13, the converter 14, the battery system 20, the first switch 30, and the second switch 40 according to a result of the monitoring. For example, the integrated controller 15 may monitor whether there is a power failure in the grid 3, whether power is generated by the power generation system 2, an amount of power generated by the power generation system 2 when power is generated by the power generation system 2, a charging state of the battery system 20, an amount of power consumed by the load 4, a time, and the like. When power to be supplied to the load 4 is insufficient (e.g., when a power failure occurs in the grid 3), the integrated controller 15 may determine priorities with respect to power consumption devices included in the load 4 and control the load 4 to supply power to the power consumption device having a high priority.

The first switch 30 and the second switch 40 are connected to each other in series between the inverter 13 and the grid 3. These switches control current flow between the power generation system 2 and the grid 3 by performing on/off operations under the control of the integrated controller 15. The on/off operation of the first switch 30 and of the second switch 40 may be determined, for example, according to a state of one or more of the power generation system 2, the grid 3, and the battery system 20.

For example, when power of the power generation system 2 and/or the battery system 20 is supplied to the load 4, or when power of the grid 3 is supplied to the battery system 20, the first switch 30 is set to an on state. When power of the power generation system 2 and/or the battery system 20 is supplied to the grid 3, or when power of the grid 3 is supplied to the load 4 and/or the battery system 20, the second switch 40 is set to an on state.

When there is a power failure in the grid 3, the second switch 40 is set to an off state and the first switch 30 is set to an on state. That is, power is supplied from the power generation system 2 and/or the battery system 20 to the load 4. At the same time, power supplied to the load 4 is prevented from flowing to the grid 3. Thus, accidents such as a worker being shocked by a power line of the grid 3 may be avoided by preventing power from being transmitted to the grid by the energy storage system 1. The first switch 30 and the second switch 40 may be any one of a variety of switching devices (e.g., a relay) capable of withstanding a large capacity current.

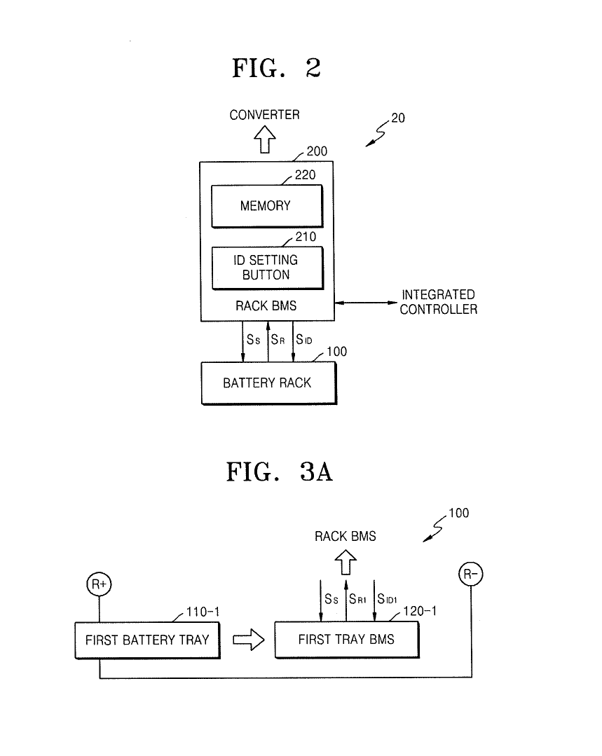

The battery system 20 receives power of the power generation system 2 and/or the grid 3 and stores the power therein. The battery system 20 supplies the power stored to the load 4 or the grid 3. The battery system 20 may include a part for storing power and a part for controlling and protecting the part for storing power. Hereinafter, the battery system 20 will be described in detail with reference to FIG. 2.

FIG. 2 illustrates an embodiment of battery system 20, which includes a battery rack 100 and a rack battery management system (BMS) 200. The battery rack 100 stores power supplied from an external source (e.g., from the power generation system 2 and/or the grid 3) and supplies the stored power to the grid 3 and/or the load 4.

The battery rack 100 may include, as a sub-unit, at least one battery tray connected in series and/or in parallel with each other, i.e., a first battery tray 110-1 through an n^{th} battery tray 110-n (n is a natural number). Also, each of the battery trays 110-1 through 110-n may include, as a sub-unit, a plurality of battery cells connected in series and/or in parallel. The battery cells may include various rechargeable secondary batteries. For example, the battery cells may include one or more of nickel-cadmium batteries, lead storage batteries, nickel metal hydride (NiMH) batteries, lithium-ion batteries, or lithium polymer batteries.

The battery rack 100 outputs required power according to a manner in which the first battery tray 110-1 through the n^{th} battery tray 110-n are connected to one another. The battery rack 100 may output power via a positive electrode output terminal R+ and a negative electrode output terminal R−. Also, the battery rack 100 may include a first tray BMS 120-1 through an n^{th} tray BMS 120-n respectively corresponding to the first battery tray 110-1 and the n^{th} battery tray 110-n.

The rack BMS 200 is connected to the battery rack 100 and controls charging and discharging of the battery rack 100. Also, the rack BMS 200 may perform functions including over-charging protection, over-discharging protection, over-current protection, over-voltage protection, over-heat protection, and/or cell balancing.

The rack BMS 200 may communicate (for example, CAN communications) with at least one tray BMS (that is, the tray BMSs 120-1 through 120-n) and collect data from the tray BMSs 120-1 through 120-n, in order to check status of battery cells and control charging/discharging of the battery cells. Respective identification information (IDs) may be assigned to the battery trays 110-1 through 110-n for collecting data or for transmitting of commands. This is different from other types of battery management systems which have been proposed.

For example, in other proposed systems, ID information is set up on circuits of the battery trays 110-1 through 110-n in terms of hardware, or ID information is already set up in memories of the battery trays 110-1 through 110-n, for example, in an electronically erasable/programmable read-only memory (EEPROM), is programmed in terms of software.

However, in these proposed systems, respective hardware or software driving mechanisms corresponding to the number of the battery trays 110-1 through 110-n existing within the battery system 20 are needed to be managed. Thus, an amount of corresponding resources increases and the driving methods become complex.

In contrast, IDs are set or allocated according to physical positions of the battery trays 110-1 through 110-n. In one embodiment, battery trays 110-1 through 110-n have their own respective IDs when manufactured. This may prove to be beneficial for failure analysis, replacement, and effective control of the batteries at each respective position.

Other proposed battery management systems do not have these features. Also, the utility of battery trays in these other systems may be strictly limited because certain battery trays are required to be mounted at certain positions in the battery system. Also, errors may occur in driving and controlling the system when the battery trays are not mounted at certain positions. Furthermore, additional errors may occur when replacing the battery trays. For example, even if the battery trays are slave boards having identical hardware and software versions, a lot of boards must be additionally prepared according to required IDs, and the software structure must be changed whenever necessary.

To solve this problem, the rack BMS 200 transmits a synchronizing signal Ss to the first tray BMS 120-1, which is connected to first battery tray 110 currently mounted. When the first tray BMS 120-1 receives the synchronizing signal Ss, the first tray BMS 120-1 transmits a response signal S_{R1} to the rack BMS 200. Upon receiving the response signal S_{R1}, the rack BMS 200 transmits ID information S_{ID} to the first tray BMS 120-1. The first tray BMS 120-1 then sets up an ID for the first battery tray based on the received ID information. The rack BMS 200 also transmits a synchronizing signal Ss whenever an additional battery tray is mounted, and then transmits ID information S_{R2} through S_{Rn} respectively for the tray BMSs 120-2 through 120-n in like manner. The rack BMS 200 may transmit the ID information for the battery trays in an order in which the battery trays are mounted or in another predetermined order.

Through this procedure, IDs for the battery trays may be provided without pre-inputting or pre-designating IDs and without programming for the battery trays 110-1 through 110-n. Also, IDs may be automatically allocated, even in cases where the battery trays operate based on identical hardware and software. Also, by sequentially allocating IDs on the basis of the physical positions of the battery trays 110-1 through 110-n to be mounted, efficient mass production of a single product is feasible. Also, product reliability may be increased as a result of mis-mounting the battery trays 110-1 through 110-n.

For ID setting, the rack BMS 200 may include an ID setting button 210 and a memory 220. When the ID setting button 210 is pressed, the battery system 20 enters into an ID setting mode. When the ID setting button 210 is re-pressed, the battery system 20 cancels the ID setting mode and returns to a normal mode. According to the present embodiment, the rack BMS 200 includes the ID setting button 210 for entering the ID setting mode. In other embodiments, the battery system 20 may enter into an ID setting mode or return to a normal mode based on an external input, which, for example, may correspond to a user command. The memory 220 stores IDs set up in the ID setting mode, and stores data transmitted from the battery rack 100 in the normal mode.

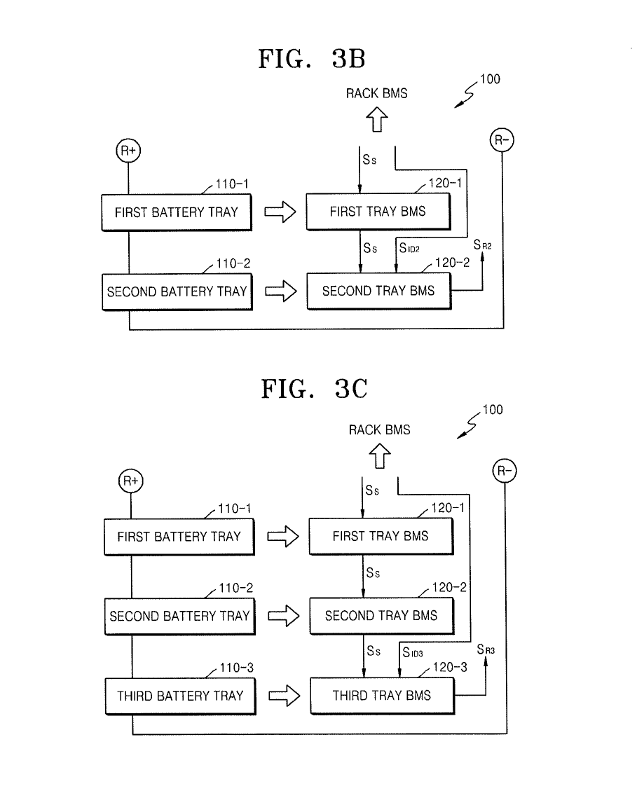

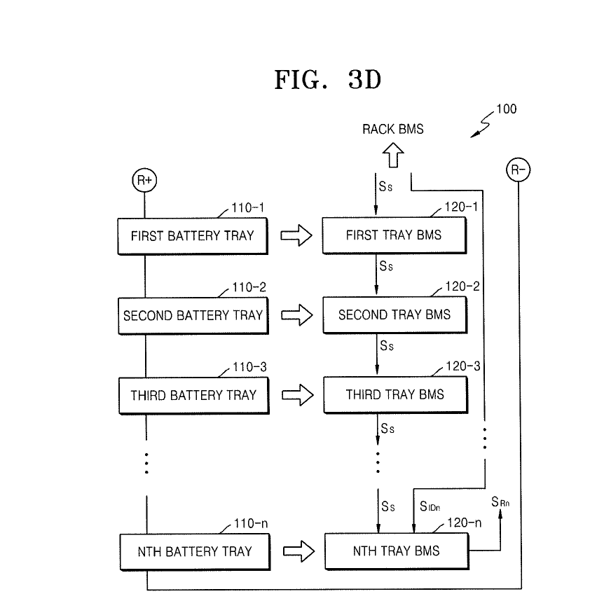

FIGS. 3A through 3D illustrate operations performed the rack BMS 200 and the tray BMSs 120-1 through 120-n for setting IDs according to one embodiment. In FIGS. 3A through 3D, the first tray BMS 120-1 through the n^{th} tray BMS 120-n correspond to the first battery tray 110-1 through the n^{th} battery tray 110-n, respectively. The first through n^{th} tray BMSs operate under a control of the rack BMS 200. The rack BMS 200 therefore may be considered to be a master BMS, and the first tray BMS 120-1 through the n^{th} tray BMS 120-n may be considered to be first through n^{th} slave BMSs. Also, it will be supposed for purposes of this embodiment that ID setting button 210 is provided, and when pressed battery system 20 enters into an ID setting mode for setting IDs of the trays.

FIG. 3A illustrates an ID setting when the first battery tray 110-1 is mounted. Referring to FIG. 3A, the rack BMS 200 operating in the ID setting mode transmits a synchronizing signal Ss (for example, FF) periodically or intermittently, for example, using a broadcasting method until returning to normal mode. When the first battery tray 110-1 is mounted, the first tray BMS 120-1 may receive the synchronizing signal Ss. The first tray BMS 120-1 receiving the synchronizing signal Ss transmits a response signal S_{R1} to the rack BMS 200. The rack BMS 200 receives the response signal S_{R1} and generates and transmits first ID information S_{ID1} (for example, #01) to the first tray BMS 120-1. The first tray BMS 120-1 sets up the received first ID #01 as the ID of the first battery tray 110-1.

After setting the ID of the first battery tray, the battery system may be restored to normal mode if the ID setting button 210 is re-pressed. That is, when this button is re-pressed, the current ID setting mode is canceled and the battery system 20 returns to the normal mode. The ID set for the first battery tray may be stored in the memory 220 simultaneously when the ID setting button 210 is re-pressed.

FIG. 3B illustrates an ID setting when a second battery tray 110-2 is mounted. The ID for the second battery tray may be set a time period after the first battery tray 110-1 is mounted. Referring to FIG. 3B, the rack BMS 200 operating in the ID setting mode transmits a synchronizing signal Ss (for example, FF) periodically or intermittently, for example, using a broadcasting method until it returns to the normal mode. When the second battery tray 120-2 is mounted a time period after the first battery tray 110-1 is mounted, the first tray BMS 120-1 and a second tray BMS 120-2 may receive the synchronizing signal Ss. The second tray BMS 120-2 receives the synchronizing signal Ss and transmits a response signal S_{R2} to the rack BMS 200.

The first tray BMS 120-1 receives the synchronizing signal Ss and transmits the response signal S_{R1} including ID #01 to the rack BMS 200. The response signal S_{R1} may be, for example an acknowledgment (ACK) signal. According to another embodiment, the first tray BMS 120-1 receives the synchronizing signal Ss and transmits no response signal S_{R1}, because it already has an ID set up. The response signal S_{R1} transmitted to the rack BMS 200 by the first tray BMS 120-1 may vary according to embodiments of a program. The response signal S_{R1} may be different from the response signal S_{R2} transmitted to the rack BMS 200 by the second tray BMS 120-2 receiving the synchronizing signal Ss.

The rack BMS 200 receives the response signal S_{R2} from the second tray BMS 120-2 and generates and transmits second ID information S_{ID2} (for example, #02) to the second tray BMS 120-2. The second tray BMS 120-2 sets up the received second ID #02 as the ID of the second battery tray 110-2. The IDs of the first battery tray 110-1 and the second battery tray 110-2 may be set up, for example, in a top-down or a bottom-up order, following an order in which the battery trays are mounted. After the ID of the second battery tray 110-2 is set up, the battery system may be restored to normal mode if the ID setting button 210 is re-pressed. When button 210 is re-pressed, the current ID setting mode is canceled and the battery system 20 returns to the normal mode. The ID set up may be stored in the memory 220 simultaneously when the ID setting button is re-pressed.

FIG. 3C illustrates an ID setting when a third battery tray 110-3 is mounted after a time period after the first battery tray 110-1 as the first battery tray and the second battery tray 110-2 as the second battery tray are mounted. Referring to FIG. 3C, the rack BMS 200 operating in the ID setting mode transmits a synchronizing signal Ss (for example, FF) periodically or intermittently, for example, using a broadcasting method until it returns to the normal mode. When the third battery tray 110-3 is mounted a time period after the first battery tray 110-1 and the second battery tray 110-2 are mounted, the first tray BMS 120-1, the second tray BMS 120-2, and a third tray BMS 120-3 may receive the synchronizing signal Ss. The third tray BMS 120-3 receives the synchronizing signal Ss and transmits a response signal S_{R3} to the rack BMS 200.

Here, the first tray BMS 120-1 and the second tray BMS 120-2 receiving the synchronizing signal Ss may transmit the response signals S_{R1} and S_{R2} including their IDs #01 and #02 to the rack BMS 200. The response signals S_{R1} and S_{R2} may be, for example, acknowledgment (ACK) signals. According to another embodiment, the first tray BMS 120-1 and the second tray BMS 120-2 having the IDs already set up may transmit no response signals S_{R1} and S_{R2} in response to the synchronizing signal Ss.

The response signals S_{R1} and S_{R2} transmitted to the rack BMS 200 by the first tray BMS 120-1 and the second tray BMS 120-2 may vary according to embodiments of a program. The response signals S_{R1} and S_{R2} may be different from the response signal S_{R3} transmitted to the rack BMS 200 by the third tray BMS 120-3.

The rack BMS 200 receives the response signal S_{R3} from the third tray BMS 120-3 and generates and transmits third ID information S_{ID3} (for example, #03) to the third tray BMS 120-3. The third tray BMS 120-3 sets up the received third ID #03 as the ID of the third battery tray 110-3. The IDs of the first battery tray 110-1, the second battery tray 110-2, and the third battery tray 110-3 may be set up in a top-down or a bottom-up order, following an order in which the battery trays are mounted.

After the ID of the third battery tray 110-3 is set up, the battery system may be restored to the normal mode if the ID setting button 210 is re-pressed. When button 210 is re-pressed, the current ID setting mode is canceled and the battery system 20 returns to the normal mode. The ID set up may be stored in the memory 220 simultaneously when the ID setting button is re-pressed.

FIG. 3D illustrates an ID setting when the n^{th} battery tray 110-n is mounted a time period after the first battery tray 110-1 as the first battery tray is mounted and the battery trays 110-2 through 110-n−1 are sequentially mounted. Referring to FIG. 3D, the rack BMS 200 operating in the ID setting mode transmits a synchronizing signal Ss (for example, FF) periodically or intermittently, for example, using a broadcasting method until it returns to the normal mode. When the n^{th} battery tray 110-n is mounted a time period after the first battery tray 110-1 is mounted and the battery trays 110-2 through 110-n−1 are mounted, the first tray BMS 120-1 through an n^{th} tray BMS 120-n may receive the synchronizing signal Ss. The n^{th} tray BMS 120-n receives the synchronizing signal Ss and transmits a response signal S_{Rn} to the rack BMS 200.

The first tray BMS 120-1 through the n−1^{th} tray BMS 120-n−1 receiving the synchronizing signal Ss may respectively transmit response signals S_{R1} through S_{Rn-1} including their IDs #01 and #02 to the rack BMS 200. Here, the response signals S_{R1} through S_{Rn-1} may be, for example, an ACK signal. According to another embodiment, the first tray BMS 120-1 through the n−1^{th} tray BMS 120-n−1 having IDs already set up may transmit no response signals S_{R1} through S_{Rn-1} in response to the synchronizing signal Ss. The response signals S_{R1} through S_{Rn-1} transmitted to the rack BMS 200 by the first tray BMS 120-1 through the n−1^{th} tray BMS 120-n−1 may vary according to embodiments of a program. The response signals S_{R1} through may be different from the response signal S_{Rn} transmitted to the rack BMS 200 by n^{th} tray BMS 120-n.

The rack BMS 200 receiving the response signal S_{Rn} from the n^{th} tray BMS 120-n generates and transmits n^{th} ID information S_{IDn} (for example, #n) to the n^{th} tray BMS 120-n. The n^{th} tray BMS 120-n sets up the received n^{th} ID #n as the ID of the n^{th} battery tray 110-n. The IDs of the first battery tray 110-1 through the n^{th} battery tray 110-n may be set up in a top-down or a bottom-up order, following an order in which the battery trays are mounted. After the ID of the n^{th} battery tray 110-n is set up, the battery system may be restored to the normal mode if the ID setting button 210 is re-pressed. When button 210 is re-pressed, the current ID setting mode is canceled and the battery system 20 returns to the normal mode. The ID set up may be stored in the memory 220 simultaneously when the ID setting button 210 is re-pressed.

By automatically allocating IDs to the battery trays, and especially when additional battery trays are mounted after a time period, the inconvenience of changing the firmware of the rack BMS may be reduced or eliminated.

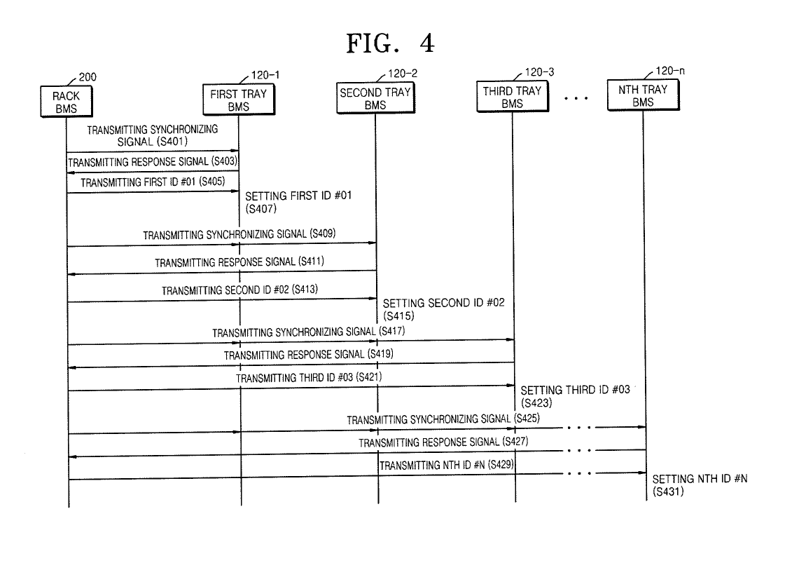

FIG. 4 shows an embodiment of a method of controlling a battery system for ID setting. This embodiment will be described in the illustrative case where the rack BMS 200 is the master BMS and the first tray BMS 120-1 through the n^{th} tray BMS 120-n is the first slave BMS through the n^{th} slave BMS. Furthermore, it will be supposed that the ID setting button 210 is pressed and the battery system 20 enters into an ID setting mode for the setting of the IDs.

Referring to FIG. 4, the master BMS operating in the ID setting mode transmits a synchronizing signal Ss (for example, FF) periodically or intermittently by using a broadcasting method until it returns to the normal mode, in operation S401.

When the first slave BMS is mounted, the first slave BMS may receive the synchronizing signal Ss. The first slave BMS receiving the synchronizing signal Ss transmits the response signal S_{R1} to the master BMS in operation 5403.

The master BMS receiving the response signal S_{R1} generates and transmits the first ID information S_{ID1} (for example, #01) to the first slave BMS in operation 405.

Then, the first slave BMS sets up the received first ID #01 as the ID of the battery tray that is firstly mounted, in operation S407. To restore the battery system 20 to normal mode, the ID setting button 210 is re-pressed to cancel current ID setting mode. The ID set up may be stored in the memory 220 simultaneously when the ID setting button 210 is re-pressed.

Next, the master BMS operating in the ID setting mode transmits a synchronizing signal Ss (for example, FF) periodically or intermittently by using a broadcasting method until it returns to the normal mode, in operation S409.

When a second slave BMS is mounted a time period after the first slave BMS is mounted, the first slave BMS and the second slave BMS may receive the synchronizing signal Ss. The second slave BMS receiving the synchronizing signal Ss transmits the response signal S_{R2} to the master BMS in operation S411. The first slave BMS receiving the synchronizing signal Ss may transmit the response signal S_{R1} including its ID #01 to the master BMS. The response signal S_{R1} may be, for example, an ACK signal. According to another embodiment, the first slave BMS receiving the synchronizing signal Ss may transmit no response signal S_{R1}, because it already has an ID set up.

The response signal S_{R1} transmitted to the master BMS by the first slave BMS may vary according to embodiments of a program. The response signal S_{R1} may be different from the response signal S_{R2} transmitted to the master BMS by the second slave BMS receiving the synchronizing signal Ss.

The master BMS receiving the response signal S_{R2} from the second slave BMS generates and transmits the second ID information S_{ID2} (for example, #02) to the second slave BMS in operation S413.

Then, the second slave BMS sets up the received second ID #02 as the ID of the battery tray that is secondly mounted, in operation S415. The IDs of the battery trays that are firstly and secondly mounted may be set up in a top-down or a bottom-up order, following an order in which the battery trays are mounted. After the ID of the battery tray that is secondly mounted is set up, the battery system 20 may be restored to the normal mode if the ID setting button 210 is re-pressed. When button 210 is repressed, the current ID setting mode is canceled and the battery system 20 returns to the non al mode. The ID set up may be stored in the memory 220 simultaneously when the ID setting button 210 is re-pressed.

Next, the master BMS operating in the ID setting mode transmits a synchronizing signal Ss (for example, FF) periodically or intermittently by using a broadcasting method until it returns to the normal mode, in operation S417.

When a third slave BMS is mounted a time period after the first slave BMS and the second slave BMS are mounted, the first slave BMS, the second slave BMS, and the third slave BMS may receive the synchronizing signal Ss. The third slave BMS receiving the synchronizing signal Ss transmits the response signal S_{R3} to the master BMS in operation S419.

The first slave BMS and the second slave BMS receiving the synchronizing signal Ss may transmit the response signals S_{R1} and S_{R2} including their IDs #01 and #02 to the master BMS. The response signals S_{R1} and S_{R2} may be, for example, an ACK signal. According to another embodiment, the first slave BMS and the second slave BMS having the IDs already set up may transmit no response signals S_{R1} and S_{R2} in response to the synchronizing signal Ss.

The response signals S_{R1} and S_{R2} transmitted to the master BMS by the first slave BMS and the second slave BMS may vary according to embodiments of a program. The response signals S_{R1} and S_{R2} may be different from the response signal S_{R3} transmitted to the master BMS by the third slave BMS.

The master BMS receiving the response signal S_{R3} from the third slave BMS generates and transmits the third ID information S_{ID3} (for example, #03) to the third slave BMS in operation S421.

Next, the third slave BMS sets up the received third ID #03 as the ID of the battery that is thirdly mounted, in operation S423. The IDs of the battery trays that are firstly, secondly, and thirdly mounted may be set up in a top-down or a bottom-up order following an order in which the battery trays are mounted. After the ID of the third battery tray is set up, the battery system 20 is restored to the normal mode if the ID setting button 210 is re-pressed. When button 210 is re-pressed, the current ID setting mode is canceled and the battery system 20 returns to the normal mode. The ID set up may be stored in the memory 220 simultaneously when the ID setting button 210 is re-pressed.

Next, the master BMS operating in the ID setting mode transmits the synchronizing signal Ss (for example, FF) periodically or intermittently by using a broadcasting method until it returns to the normal mode, in operation S425.

When the n^{th} slave BMS is mounted after the second through an n−1^{th} slave BMSs are mounted a time period after the first slave BMS is mounted, the first through the n^{th} slave BMSs may receive the synchronizing signal Ss. The n^{th} slave BMS receiving the synchronizing signal Ss transmits the response signal S_{Rn} to the master BMS in operation S427. The first through the n−1^{th} slave BMSs receiving the synchronizing signal Ss may respectively transmit response signals S_{R1} through S_{Rn-1} including their IDs #01 and #02 to the master BMS. The response signals S_{R1} through S_{Rn-1} may be, for example, ACK signals. According to another embodiment, the first through the n−1^{th} slave BMSs having IDs already set up may transmit no response signals S_{R1} through S_{Rn-1} in response to the synchronizing signal Ss.

The response signals S_{R1} through S_{Rn-1} transmitted to the master BMS may vary according to embodiments of a program. The response signals S_{R1} through S_{Rn-1} may be different from the response signal S_{Rn} transmitted to the master BMS by the n^{th} slave BMS receiving the synchronizing signal Ss.

The master BMS receiving the response signal S_{Rn} from the n^{th} slave BMS generates and transmits n^{th} ID information S_{IDn} (for example, #n) to the n^{th} slave BMS in operation S429.

Then, the n^{th} slave BMS sets up the received n^{th} ID #n as the ID of the battery tray that is mounted in the n^{th} order, in operation S431. The IDs of the battery trays that are mounted in the first through n^{th} order may be set up in a top-down or a bottom-up order, following an order in which the battery trays are mounted. After the ID of the battery tray that is mounted in the n^{th} order is set up, the battery system 20 may be restored to the normal mode if the ID setting button 210 is re-pressed. When button 210 is repressed, the current ID setting mode is canceled and the battery system 20 returns to the normal mode. The ID set up may be stored in the memory 220 simultaneously when the ID setting button 210 is re-pressed.

As described above, according to the one or more of the above embodiments, by automatically allocating IDs to battery trays that are additionally mounted after a time period, the inconvenience of changing a firmware of the rack BMS may be removed.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of controlling a battery system, the method comprising:
(a) transmitting a synchronizing signal from a master battery management system (BMS);
(b) transmitting a response signal from a slave BMS to the master BMS when a battery tray corresponding to the slave BMS is mounted;
(c) transmitting identification (ID) information from master BMS to the slave BMS;
(d) setting the received ID information in the slave BMS; and
(e) repeating (b), (c), and (d) when one or more additional battery trays having corresponding slave BMSs are mounted.

2. The method as claimed in claim 1, further comprising:
sequentially transmitting the ID information of each slave BMS in an order in which corresponding ones of the battery trays are mounted.

3. The method as claimed in claim 1, further comprising:
changing a mode of the master BMS to an ID setting mode based on an external input.

4. The method as claimed in claim 3, wherein the external input is generated when an ID setting button is pressed.

5. The method as claimed in claim 3, further comprising:
changing the mode of the master BMS to a normal mode based on another external input.

6. The method as claimed in claim 5, wherein the other external input is generated by re-pressing an ID setting button.

7. The method as claimed in claim 5, further comprising:
storing the ID information when the mode of the master BMS is changed to the normal mode.

8. The method as claimed in claim 1, wherein the master BMS communicates with the slave BMS based on controller area network (CAN) communications.

9. A battery system, comprising:
at least one slave battery management system (BMS) to control a battery tray including at least one battery cell; and
a master BMS to control the at least one slave BMS, wherein:
the master BMS is configured to transmit a synchronizing signal, receive a response signal from the slave BMS receiving the synchronizing signal, transmit ID information of the slave BMS to the slave BMS, and repeatedly performing receiving of the response signal and transmitting of the ID information whenever an additional battery tray with a corresponding slave BMS is mounted, and
the slave BMS is configured to receive the synchronizing signal and transmit the response signal to the master BMS, when the battery tray corresponding to the slave BMS is mounted, and to receive the ID information from the master BMS.

10. The battery system as claimed in claim 9, wherein the master BMS sequentially transmits the ID information of each slave BMS in an order in which the battery trays are mounted.

11. The battery system as claimed in claim 9, wherein the master BMS enters into an ID setting mode based on an external input.

12. The battery system as claimed in claim 11, wherein the master BMS further comprises an ID setting button for entering into the ID setting mode.

13. The battery system as claimed in claim 11, wherein the master BMS returns to a normal mode based on another external input.

14. The battery system as claimed in claim 13, wherein the external input is generated when an ID setting button is re-pressed.

15. The battery system as claimed in claim 13, wherein the master BMS stores the ID information when returning to the normal mode.

16. The battery system as claimed in claim 9, wherein the master BMS and slave BMS perform controller area network (CAN) communications.

17. An energy storage system, comprising:
a connection to a power generation system;
a connection to a power grid system; and
a battery system including at least one slave battery management system (BMS) for controlling a battery tray including at least one battery cell and a master BMS for controlling the at least one slave BMS, wherein the battery system, the power generation system, the power grid system are connected to supply power to a load,
wherein the master BMS transmits a synchronizing signal, receives a response signal from the slave BMS on which the battery tray receiving the synchronizing signal is mounted, transmits ID information of the slave BMS to the slave BMS, repeatedly performs the receiving and transmitting of the ID information when an additional battery tray is mounted, and
wherein the master BMS sequentially transmits the ID information of each slave BMS in an order in which the battery trays are mounted.

18. A method of controlling a battery system, the method comprising:
transmitting a synchronizing signal from a first battery management system (BMS) to a plurality of second BMSs;
receiving response signals from the second BMSs; and
transmitting identification (ID) information from the first BMS to respective ones of the second BMSs after the response signals are received, wherein the ID information for the second BMSs are different from one another.

19. The method as claimed in claim 18, wherein the response signals from the second BMSs are sequentially received by the first BMS.

20. The method as claimed in claim 18, wherein the first BMS receives response signals from the second BMSs when corresponding battery trays are connected.
